(19) United States
(12) Patent Application Publication
(10) Pub. No.: US 2024/0331371 A1
(43) Pub. Date: Oct. 3, 2024

(54) METHODS AND APPARATUS TO PERFORM PARALLEL DOUBLE-BATCHED SELF-DISTILLATION IN RESOURCE-CONSTRAINED IMAGE RECOGNITION APPLICATIONS

(71) Applicant: Intel Corporation, Santa Clara, CA (US)

(72) Inventors: Yurong Chen, Beijing (CN); Anbang Yao, Beijing (CN); Ming Lu, Beijing (CN); Dongqi Cai, Beijing (CN); Xiaolong Liu, Beijing (CN)

(21) Appl. No.: 18/573,973

(22) PCT Filed: Nov. 30, 2021
(86) PCT No.: PCT/CN2021/134300

§ 371 Date: Dec. 22, 2023

(51) Int. Cl. G06V 10/82

(52) U.S. Cl. CPC G06V 10/82

(57) ABSTRACT

Methods and apparatus to perform parallel double-batched self-distillation in resource-constrained image recognition environments are disclosed herein. Example apparatus disclosed herein are to identify a source data batch and an augmented data batch, the augmented data generated based on at least one data augmentation technique. Disclosed example apparatus is also to share one or more parameters between a student neural network corresponding to the source data batch and a teacher neural network corresponding to the augmented data batch, the one or more parameters including one or more convolution layers to be shared between the teacher neural network and the student neural network. Disclosed example apparatus is further to align knowledge corresponding to the teacher neural network and the student neural network, the knowledge corresponding to the one or more parameters shared between the student neural network and the teacher neural network.

### FIELD OF THE DISCLOSURE

This disclosure relates generally to image recognition systems, and, more particularly, to methods and apparatus to perform parallel double-batched self-distillation in resource-constrained image recognition applications.

### BACKGROUND

Deep neural networks (DNNs) have revolutionized the field of artificial intelligence (AI) as applied in many domains including computer vision, speech processing, and natural language processing. At least some DNN-based learning algorithms focus on how to efficiently execute already trained models (e.g., using inference) and how to evaluate DNN computational efficiency. Improvements in efficient training of DNN models can be useful in areas of image recognition/classification, machine translation, speech recognition, and recommendation systems, among others.

### BRIEF DESCRIPTION OF THE DRAWINGS

FIG. 1 illustrates an example system to implement an example parallel double-batched self-distillation process disclosed herein.

FIG. 2 illustrates a block diagram of example data generation circuitry constructed in accordance with teachings of this disclosure for performing data generation in the example system of FIG. 1.

FIG. 3 illustrates a block diagram of example parameter share circuitry constructed in accordance with teachings of this disclosure for performing parameter sharing in the example system of FIG. 1.

FIG. 4 illustrates a block diagram of example knowledge adjustment circuitry constructed in accordance with teachings of this disclosure for performing knowledge adjustment in the example system of FIG. 1.

FIG. 5 illustrates a block diagram of example self-distillation circuitry constructed in accordance with teachings of this disclosure for performing self-distillation in the example system of FIG. 1.

FIG. 6 is a flowchart representative of example machine readable instructions that may be executed by example processor circuitry to implement the data generation circuitry of FIG. 2, the parameter share circuitry of FIG. 3, the knowledge alignment circuitry of FIG. 4, and/or the self-distillation circuitry of FIG. 5.

FIG. 7 is a flowchart representative of example machine readable instructions that may be executed by example processor circuitry to implement the data generation circuitry of FIG. 2.

FIG. 8 is a flowchart representative of example machine readable instructions that may be executed by example processor circuitry to implement the parameter share circuitry of FIG. 3.

FIG. 9 is a flowchart representative of example machine readable instructions that may be executed by example processor circuitry to implement the knowledge alignment circuitry of FIG. 4.

FIG. 10 is a flowchart representative of example machine readable instructions that may be executed by example processor circuitry to implement the self-distillation circuitry of FIG. 5.

FIG. 11 illustrates example accuracy results obtained when training machine learning and/or computer vision algorithms on a given network, including with the use of the parallel double-batched self-distillation process disclosed herein.

FIG. 12 is a block diagram of an example processing platform including processor circuitry structured to execute the example machine readable instructions of FIGS. 6-10 to implement the data generation circuitry of FIG. 2, the parameter share circuitry of FIG. 3, the knowledge alignment circuitry of FIG. 4, and/or the self-distillation circuitry of FIG. 5.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 6, 7, 8, 9, 10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Deep neural networks (DNNs) have revolutionized the field of artificial intelligence (AI) as applied in many domains including computer vision, speech processing, and natural language processing. More specifically, neural networks are used in machine learning to allow a computer to learn to perform certain tasks by analyzing training examples. For example, an object recognition system can be fed numerous labeled images of objects (e.g., cars, trains, animals, etc.) to allow the system to identify visual patterns in such images that consistently correlate with a particular object label. DNNs rely on multiple layers to progressively extract higher-level features from raw data input (e.g., from identifying edges of a human being using lower layers to identifying actual facial features using higher layers, etc.).

Modern DNN-based architectures include excessive learnable parameters stacked with complex topologies. While an abundance of parameters can help the network with fitting training data and enabling the achievement of a high level of performance, this can introduce intensive memory and computational cost, thereby resulting in increased power consumption. Additionally, the presence of a multitude of learnable parameters can make the network more difficult to train and converge. Some prior methods use model compression and/or acceleration to transform large, powerful DNN models into more compact and/or efficient models. Some prior methods of accelerating DNN performance can be divide into several categories, including sparse networks, low-rank factorization, and/or knowledge distillation. For example, sparse networks can be used to make the network more compact using parameter pruning, quantization and binarization, and/or structural matrices. Low-rank factorization can be used to decompose a three-dimensional tensor into a sparsity structure, while knowledge distillation (KD) can be used to compress deep and wide networks into shallower ones, such that the compressed model mimics one or more function(s) learned by the more complex network model. For example, KD includes a model compression method in which a smaller neural network (e.g., a student neural network, a secondary neural network, etc.) is trained to mimic a pre-trained, larger neural network (e.g., a teacher neural network a primary neural network, etc.). In neural networks, neural-like processing elements locally interact through a set of unidirectional weighted connections, where knowledge is internally represented by values of the neural network weights and topology of the neural network connections. For example, the term knowledge as it relates to knowledge distillation refers to class-wise probability score(s) predicted by neural network(s). As such, KD can be used to train a compact neural network using distilled knowledge extrapolated from a larger model or ensemble of models. For example, the distilled knowledge can be used to train smaller and more compact models efficiently without compromising the performance of the compact model. In some examples, knowledge is transferred from the teacher neural network to the student neural network by minimizing a loss function.

However, multiple disadvantages exist when using known techniques of accelerating DNN performance. For example, when using network pruning, pruning criteria can require manual setup of sensitivity for layers, which demands fine-tuning of the parameters and can be cumbersome for some applications. One issue of structural matrix approaches is that structural constraint(s) can hurt network performance since such constraint(s) can introduce bias to the model. Likewise, a proper structural matrix can be difficult to identify given a lack of theoretical-based derivations for identifying such a matrix. Other methods such as low-rank approximation-based approaches involve the use of a decomposition operation, which is computationally expensive, while factorization requires extensive model retraining to achieve convergence when compared to the original model. Likewise, prior KD techniques do not assimilate knowledge between original data and transformed data, thereby allowing a network trained under transformed data to lose knowledge associated with the original (e.g., source) data.

Methods and apparatus disclosed herein permit improvement of DNN performance on resource-constrained devices. In the examples disclosed herein, parallel double-batched self-distillation (PadBas) is introduced to improve DNN performance on resource-constrained devices by focusing on transformations related to data operation, network structure, and/or knowledge distillation to allow for network efficiency while maintaining accuracy. In the examples disclosed herein, the use of parallel double-batched self-distillation introduces a compact yet efficient method of obtaining network performance gain and making the network easily trainable. For example, PadBas can be used to assimilate knowledge between original data and transformed data through data operation. Since the network trained under transformed data can lose knowledge on source data, the knowledge on the source data is maintained and the learning of new knowledge on transformed data can be used to boost network performance. Furthermore, PadBas includes a convolution layers parameter sharing strategy to make teacher-student networks more expressive. For example, during training the teacher and student networks can be set to share their convolution layer parameter(s) while maintaining independence within batch normalization layer(s). As such, methods and apparatus disclosed herein allow DNN-based knowledge (e.g., obtained from the student network, teacher network, etc.) to be aligned together while still maintaining differences between knowledge variances. Additionally, the use of deep mutual learning and deep ensemble learning can make the learning process more effective.

In the examples disclosed herein, parallel double-batched self-distillation (PadBas) can be adapted to train any kind of DNN with knowledge distillation to achieve a competitive accuracy when compared to the use of a teacher-based network on a single model. For example, PadBas can introduce significant improvement in accuracy on a single network, even when the network becomes deeper, denser, and/or wider, allowing the final model to be used in diverse artificial intelligence (AI)-based applications. As such, methods and apparatus disclosed herein allow for ease of operation associated with obtaining double-batched data and create a compact network structure with a parameter sharing scheme that can be applied to any kind of DNN with knowledge distillation. In the examples disclosed herein, the PadBas algorithm includes a data generator module, a parameter shared module, a knowledge alignment module, and/or a self-distillation module. For example, the PadBas algorithm can be used to assimilate knowledge from a shared two-branch network with double-batched data input. Methods and apparatus disclosed herein introduce a user-friendly training procedure with teacher-student networks being trained simultaneously from scratch and/or being pretrained, thereby allowing parallel double-batched self-distillation to be applicable for use in diverse AI tasks.

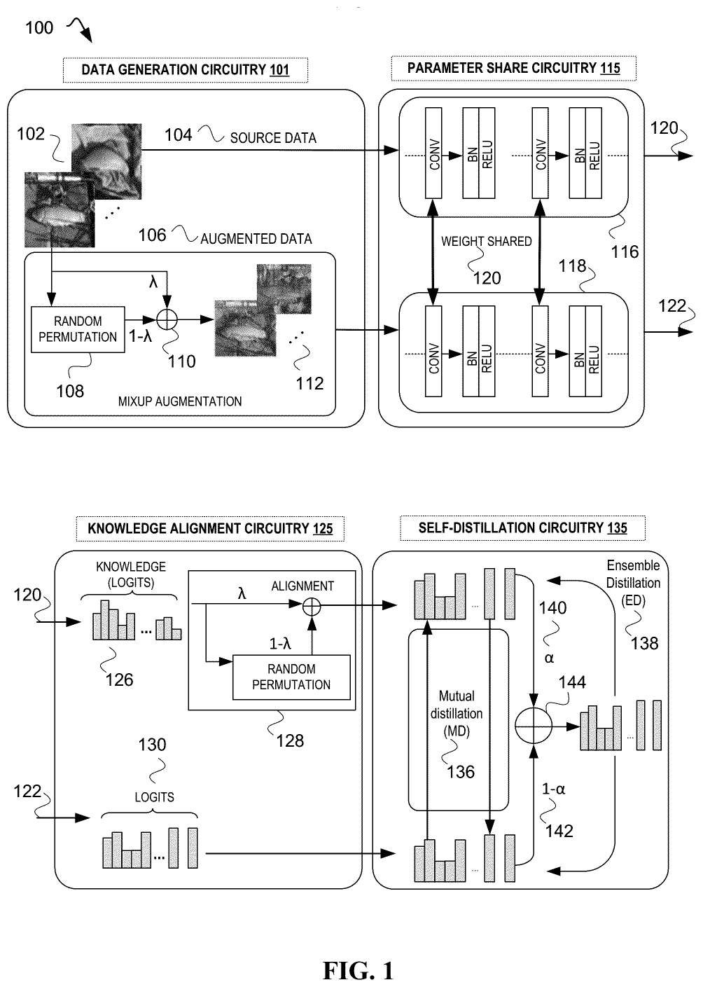

FIG. 1 illustrates an example system or apparatus 100 to implement a parallel double-batched self-distillation (PadBas) process as disclosed herein. The example PadBas system or apparatus 100 includes example data generation circuitry 101, example parameter share circuitry 115, example knowledge alignment circuitry 125, and/or example self-distillation circuitry 135. In the example of FIG. 1, the data generation circuitry 101 receives input dataset(s) 102 (e.g., images, etc.) used to perform data operation(s) and output double-batched data, including source data 104 and transformed and/or augmented data 106. In some examples, data augmentation can be used to boost model performance by feeding a given model with data that is operated from source data to reduce the problem of overfitting and increase the network's generalization. While such data augmentation methods (e.g., MixUp, CutMix, AutoAug, etc.) can level up a model's performance, augmentation does not necessarily benefit overall accuracy and can instead contribute to a decrease in model accuracy. In the example of FIG. 1, source input is defined as the original data. In some examples, the original data can include modifications performed based on simple operations (e.g., flip, resize, crop, etc.), while augmented input includes data that has undergone more advanced operations involving data augmentation methods (e.g., MixUp, CutMix, AutoAug, etc.). For example, while in a real-world scenario a dataset of images (e.g., input dataset(s) 102) is derived from a limited set of conditions, target applications exist in a variety of conditions (e.g., different orientations, locations, scales, brightness, etc.). By training a network with data augmentation, overfitting can be reduced during training while also increasing generalization. In some examples, data augmentation can be based on basic image geometric transformations (e.g., flipping, cropping, rotation, translation, noise injection, etc.), as well as color space transformation and/or simple color transforms. In some examples, mixing images by averaging their pixel values (e.g., using a MixUp operation) can provide new training datasets, contributing to improved model performance as comparted to using baseline models. For example, inclusion of mixed images in the training dataset can reduce training time and/or increase the diversity of sample used in various network (e.g., generative adversarial networks). In some examples, other operations can be used, including mixing randomly cropped images and concatenating the cropped images together to form new images (e.g., using a CutMix operation).

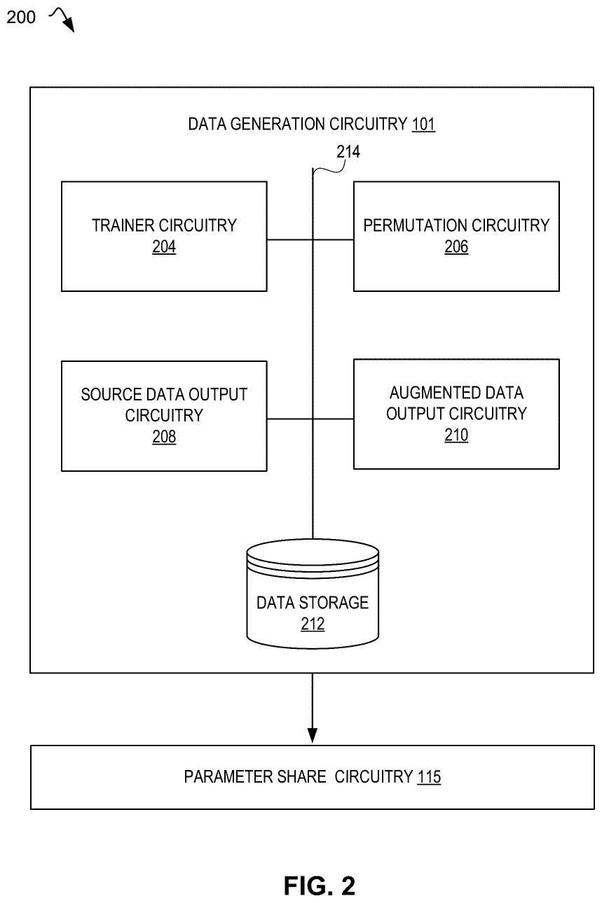

In the example of FIG. 1, a MixUp augmentation process can be used to obtain augmented data 106. In some examples, the augmented data 106 is obtained using a random permutation 108 of a sequence of samples, as described in more detail in connection with FIG. 2. For example, the augmented data 106 can be determined based on sampling from a beta distribution to mix image features and/or their corresponding labels (e.g., represented by lambda (λ) values with the [0, 1] range sampled from the beta distribution). Furthermore, an example direct sum of vector spaces 110 can be used to identify the augmented data 106 as represented by example augmented image dataset(s) 112. While the MixUp operation is used in the example of FIG. 1 to perform data augmentation, any other type of data augmentation algorithm can be used to generate a new dataset (e.g., augmented image dataset 112) from the original dataset (e.g., input dataset 102). As such, the data generation circuitry 101 outputs two branches of data: the source data 104 and the augmented data 106. The parameter share circuitry 115 receives the source data 104 and/or the augmented data 106. In the example of FIG. 1, the parameter share circuitry 115 includes an example secondary neural network (e.g., a student model, a student neural network) 116 and/or an example primary neural network (e.g., teacher model, a teacher neural network) 118 defined using the source data and/or the augmented data, respectively. In the example of FIG. 1, the secondary neural network 116 and the primary neural network 118 include weight sharing 120, which permits convolution layers to be shared between the networks 116, 118, while the batch normalization (BN) layer(s) remain separated. For example, training DNNs with many layers can be challenging given that the network can be sensitive to random weights and/or configuration of the learning algorithm. Batch normalization permits training DNNs by standardizing the inputs to a layer for each mini-batch, thereby stabilizing the learning process and reducing the number of training epochs required to train the network. As such, batch normalization can be performed between layers of a neural network instead of in the original raw data, with normalization taking place in mini-batches instead of on the full data set, resulting in faster training of the network and the use of higher learning rates. Furthermore, an example batch normalization layer (e.g., indicated as BN in the secondary neural network 116 and the primary neural network 118) can normalize a mini-batch of data across all observations for each channel independently. In some examples, batch normalization layers can be used between convolutional layers (e.g., indicated as CONV in the secondary neural network 116 and the primary neural network 118) and nonlinearities, such as Rectified Linear Units (ReLUs). For example, after each CONV layer in a convolutional neural network (CNN), a nonlinear activation function can be applied (e.g., ReLU, ELU, or any other Leaky ReLU variants). By introducing weight sharing 120 between convolution layers as shown in the example of FIG. 1, the network can be used to obtain more knowledge in common between the primary neural network and/or the secondary neural network, forming different distributions through the batch normalization layers to improve network accuracy. While in the examples described herein the example neural network used is a CNN, the methods and apparatus disclosed herein can be applied to any other type of neural network. In particular, CNNs are widely applied in large-scale computer vision and video recognition applications, including other tasks such as style transfer, object tracking, 3D reconstruction, as well as facial and action-based recognition.

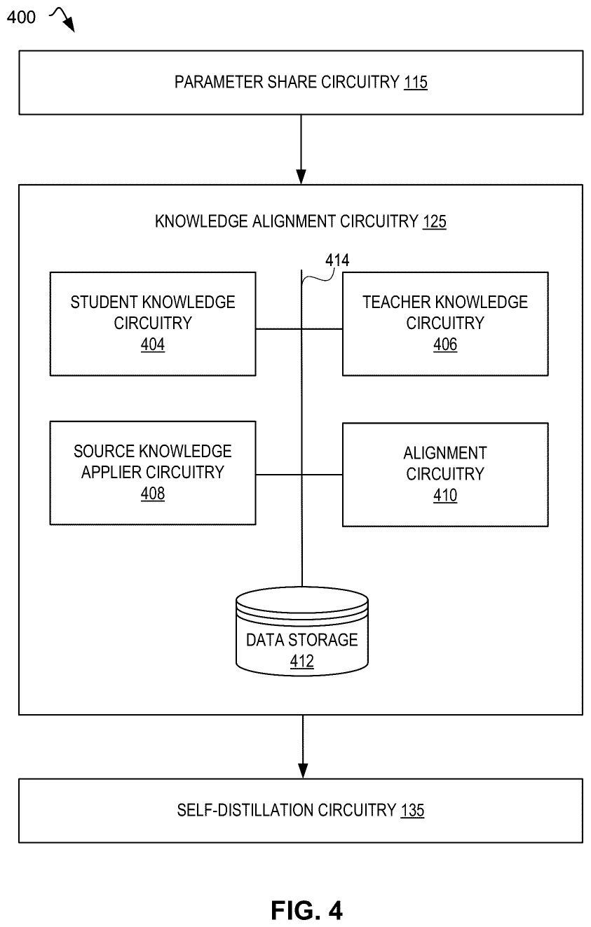

Output from the parameter share circuitry 115 is transferred to the knowledge alignment circuitry 125 in two example parallel data flows 120, 122 corresponding to source-based data input and augmented data input (e.g., source data 104 and augmented data 106). Prior to knowledge distillation (e.g., performed using the self-distillation circuitry 135), the two parallel data flows 120, 122 are aligned together using the knowledge alignment circuitry 125. In the example of FIG. 1, the knowledge alignment includes the use of MixUp data augmentation to perform permutation on logits of student-derived knowledge 126, as described in more detail in connection with FIG. 4. For example, a neural network can produce class probabilities by using a softmax output layer that converts a logit computed for each class into a probability by comparing the logit with other logits. For example, the logits of student-derived knowledge 126 are passed through random permutation to achieve knowledge alignment 128, as previous described in connection with random permutations performed to generate augmented data 106 (e.g., involving the use of source data 104), while logits of teacher-derived knowledge 130 are passed directly to the self-distillation circuitry 135, such that output from the knowledge alignment circuitry 125 is provided to the self-distillation circuitry 135, which represents knowledge distillation (KD).

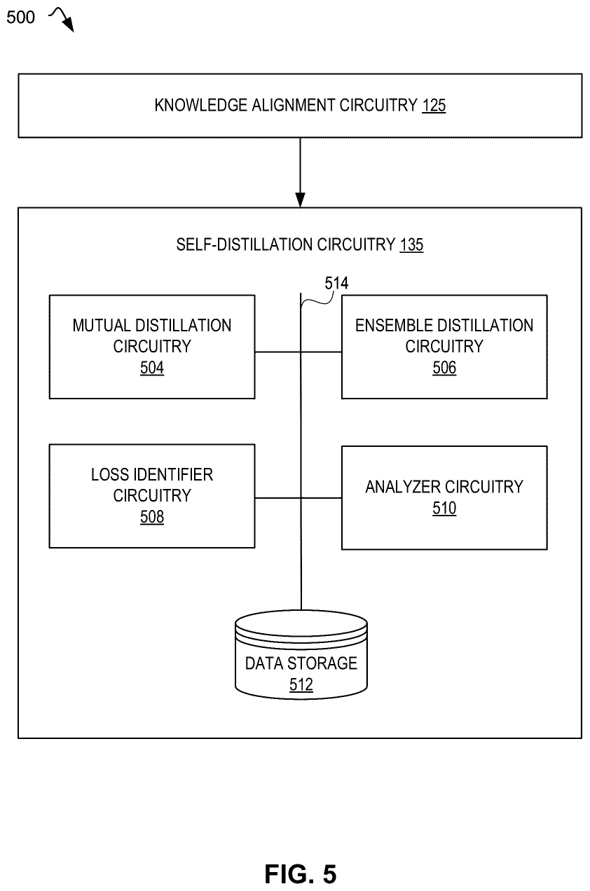

In general, KD represents the learning of a small model from a large model, such that a small student model (e.g., a student neural network) is supervised by a large teacher neural network, and can be employed to allow for model compression when transferring information from a large model or an ensemble of models into training a small model without a significant drop in accuracy. For example, while DNNs can be used to achieve a high level of performance in computer vision, speech recognition, and/or natural language processing tasks, such models are too expensive computationally to be executed on devices which are resource-constrained (e.g., mobile phones, embedded devices, etc.). In some examples, highly complex teacher networks can be trained separately using a complete dataset (e.g., requiring high computational performance). In some examples, correspondence is established between the teacher network and the student network (e.g., passing the output of a layer in the teacher network to the student network). In the example of FIG. 1, the self-distillation module implements mutual distillation 136 and/or ensemble distillation 138 for purposes of performing knowledge distillation. For example, mutual distillation 138 operates on the two branch outputs of the knowledge alignment circuitry 125 (e.g., logits of student-derived knowledge obtained using knowledge alignment 128, logits of teacher-derived knowledge 130), as described in more detail in connection with FIG. 5. Additionally, the ensemble distillation 138 is performed using the mutually distilled data from the student and teacher-derived knowledge to achieve an ensemble-based knowledge based on Kullback-Liebler divergence (e.g., used to determine how a first probability distribution differs from a second, reference probability distribution). In the example of FIG. 1, losses in the self-distillation module are added together to form a total KD loss (e.g., based on alpha hyperparameter values 140, 142). In some examples, a weighted average can be used between the distillation loss and the student loss (e.g., 1−α), with a combined knowledge output 144 identified using ensemble distillation 138. As described in connection with FIG. 5, the total KD loss can include loss identified between the student branch logits and ground truth data, loss identified using the teacher branch defined by the MixUp data augmentation, and/or loss on ensemble logits. The knowledge distillation results in improved model performance in the presence of resource-constrained image recognition applications. For example, a smaller model (e.g., student neural network) can be trained to mimic a pre-trained, larger model (e.g., teacher neural network), such that knowledge is transferred from the teacher neural network to the student neural network by minimizing the loss function (e.g., using the distribution of class probabilities predicted by the larger model). For example, deployment of a trained model to many users introduces latency and computational resource requirements. KD can be used to transfer knowledge from larger DNN models to smaller models that are more suitable for deployment. Distilling the knowledge from a larger model to a smaller model allows for the training of the smaller model to generalize in the same way that a larger model would generalize.

FIG. 2 illustrates a block diagram 200 of an example implementation of the data generation circuitry 101 of FIG. 1. In FIG. 2, the data generation circuitry 101 includes example trainer circuitry 204, example permutation circuitry 206, example source data output circuitry 208, example augmented data output circuitry 210, and/or example data storage 212. The trainer circuitry 204, the permutation circuitry 206, the source data output circuitry 208, the augmented data output circuitry 210, and/or the data storage 212 are in communication using an example bus 214.

The trainer circuitry 204 trains model (M) parameters using forward and/or backward propagation. For example, the example data generation circuitry 101 outputs two branches of data (e.g., augmented data and source data), where x∈R^{W×H×C} and y∈{0, 1 . . . , n} denote a sample and the sample's label, respectively, with n representing the number of classes, x, y denoting a given dataset and the dataset's labels, W representing a width of the dataset x, H representing a height of the dataset x, and C representing channels of x corresponding to another tensor dimension. In the examples disclosed herein, x is assumed to consists of real number values, whereas y is assumed to consist of integers. The parameters of a model (θ) can be trained according to Equation 1, as shown below, using a loss function, where argmin corresponds to an argument of the minimum (e.g., a value for which the loss function attains its minimum):

$${arg}_{θ} min Loss ( M ( x , \vert θ ) , y ) \qquad Equation 1$$

For example, the loss function serves as the difference between predicted and actual values. Backpropagation can be used to adjust random weights to make the output more accurate, given that during forward propagation weights are initialized randomly. The loss function is used to find the minima of the function to optimize the model and improve the prediction's accuracy. In some examples, the loss can be reduced by changing weights, such that the loss converges to the lowest possible value.

The permutation circuitry 206 performs random permutation(s) on a sequence of samples as part of the data generation circuitry 101. For example, when implementing data augmentation (e.g., MixUp, CutMix, AutoAug, etc.) in a mini-batch (Xₘ) corresponding to a subset of the total dataset, the MixUp augmentation can be performed according to Equations 2 and 3 using random permutation:

$${X}_{m}^{r} = RandPerm ( {X}_{m} ) \qquad Equation 1$$

$${X}_{m}^{a u g} = λ {X}_{m} + ( 1 - λ ) {X}_{m}^{r} \qquad Equation 2$$

In the example of Equation 1, the RandPerm operation is a random permutation of the sequence of samples in Xₘ. In some examples, the augmented data (Xₘ^{avg}) can be obtained based on lambda (λ) values which are sampled from the beta distribution β(α, α). For example, image features and/or their corresponding labels can be mixed based on λ values within the [0, 1] range sampled from the beta distribution, as illustrated in connection with the data generation circuitry 101 shown in FIG. 1. While in the examples disclosed herein the MixUp operation is used for data augmentation, any other data augmentation algorithm can be used which generates a new dataset (e.g., an augmented dataset 106 of FIG. 1) from the original dataset.

The source data output circuitry 208 outputs the source data 104 of FIG. 1 as part of the two-branched flow of data coming from the data generation circuitry 101 to the parameter share circuitry 115. For example, since a network trained under transformed data (e.g., data augmented using MixUp augmentation, etc.) can lose knowledge on source data, the knowledge on the source data is maintained using the source data output circuitry 208 and the learning of new knowledge on transformed data (e.g., augmented data 106) can be used to boost network performance. As previously described, while data augmentation can be used to boost model performance to reduce the problem of overfitting and increase the network's generalization, augmentation does not necessarily benefit overall accuracy and can instead contribute to a decrease in model accuracy. Therefore, the retention of the source data during training permits increased model accuracy.

The augmented data output circuitry 210 outputs the augmented data 106 as part of the two-branched flow of data coming from the data generation circuitry 101 to the parameter share circuitry 115. For example, the augmented data output circuitry 210 provides the augmented data obtained as a result of random permutation operations performed as part of a MixUp data augmentation and/or any other data augmentation methods (e.g., CutMix, AutoAug, etc.).

The data storage 212 can be used to store any information associated with the trainer circuitry 204, the permutation circuitry 206, the source data output circuitry 208, and/or the augmented data output circuitry 210. The example data storage 212 of the illustrated example of FIG. 2 can be implemented by any memory, storage device and/or storage disc for storing data such as flash memory, magnetic media, optical media, etc. Furthermore, the data stored in the example data storage 212 can be in any data format such as binary data, comma delimited data, tab delimited data, structured query language (SQL) structures, image data, etc.

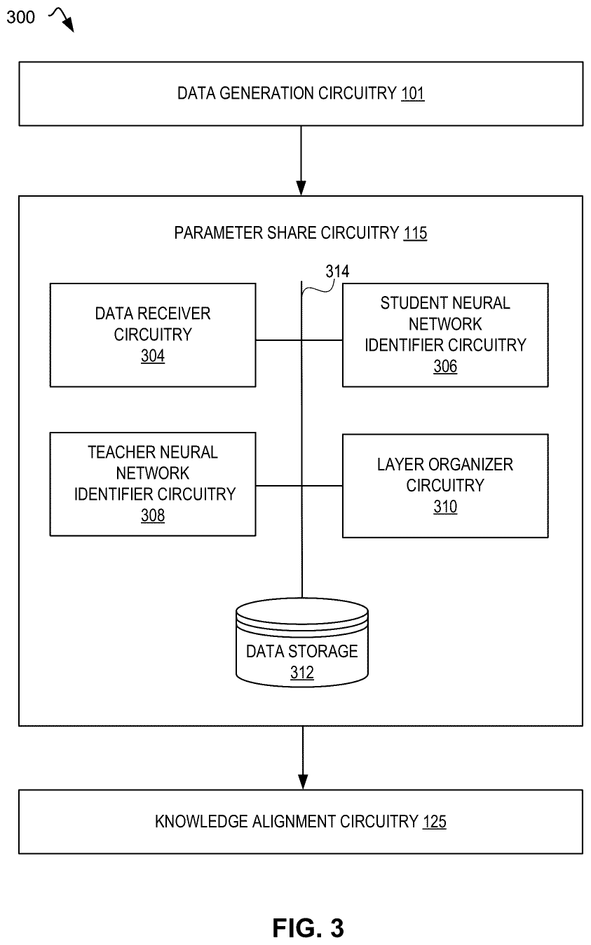

FIG. 3 illustrates a block diagram 300 of an example implementation of the parameter share circuitry 115 of FIG. 1. In FIG. 3, the parameter share circuitry 115 includes example data receiver circuitry 304, example student neural network identifier circuitry 306, example teacher neural network identifier circuitry 308, example layer organizer circuitry 310, and/or example data storage 312. The data receiver circuitry 304, the student neural network identifier circuitry 306, the teacher neural network identifier circuitry 308, the layer organizer circuitry 310, and/or the data storage 312 are in communication using an example bus 314.

The data receiver circuitry 304 receives the source data (e.g., source data 104 of FIG. 1) from the source data output circuitry 208 of FIG. 2 and/or the augmented data (e.g., augmented data 106 of FIG. 1) from the augmented data output circuitry 210. While in some examples the source output is defined as the original data which has been modified using simple operations (e.g., flip, resize, crop, etc.), the augmented data input provided by the augmented data output circuitry 210 includes data that has been modified using advanced operations involving data augmentation methods (e.g., MixUp, CutMix, AutoAug, etc.).

The student neural network identifier circuitry 306 generates a student neural network (M_{S}) as part of the parameter share circuitry 115. In some examples, the student neural network identifier circuitry 306 defines student knowledge (e.g., parametrized using θₛ) as Kₛ (X)=p (·|X, θₛ), where θₛ represents student (s) neural network parameters (e.g., parameters of a convolutional neural network). For example, Kₛ (X) represents a probability (p) conditioned on the input X and the neural networks parameter (e.g., student-based neural network parameter θₛ). For example, the student neural network and the teacher neural network include weight sharing (e.g., weight sharing 120), which permits convolution (CN) layers to be shared between the models, while the batch normalization (BN) layer(s) remain separated. Weight sharing 120 between convolution layers as shown in the example of FIG. 1 permits the network to obtain more knowledge in common between the teacher neural network and/or the student neural network, forming different distributions through the batch normalization layers to improve network accuracy.

The teacher neural network identifier circuitry 308 generates a teacher neural network (M_{T}) as part of the parameter share circuitry 115. In some examples, the teacher neural network identifier circuitry 308 defines teacher knowledge (e.g., parametrized using θₜ) as Kₜ(X)=p (·|X, θₜ), where θₜ represents teacher (t) neural network parameters (e.g., parameters of a convolutional neural network). For example, Kₜ (X) represents a probability (p) conditioned on the input X and the neural networks parameter (e.g., teacher-based neural network parameter θₜ). For example, a smaller model (e.g., student neural network) can be trained to mimic a pre-trained, larger model (e.g., teacher neural network neural network), such that knowledge is transferred from the teacher neural network neural network to the student neural network by minimizing the loss function (e.g., using the distribution of class probabilities predicted by the larger model).

The layer organizer circuitry 310 sets the teacher neural network (M_{T}) and the student neural network (M_{S}) to share their convolution layer parameter(s) while maintaining independence within batch normalization layer(s), as shown in the example of FIG. 1. For example, by separating the batch normalization layers, the layer organizer circuitry 310 makes the model learn more data distribution on the two branches of data, thereby increasing model accuracy. In some examples, the layer organizer circuitry 310 uses batch normalization (BN) layers between convolutional (CONV) layers (e.g., when implementing PadBas on a convolutional neural network) and nonlinearities (e.g., Rectified Linear Units (ReLUs)). For example, the layer organizer circuitry 310 can apply a nonlinear activation function (e.g., ReLU, ELU, etc.) after each CONV layer in a convolutional neural network.

The data storage 312 can be used to store any information associated with the data receiver circuitry 304, student neural network identifier circuitry 306, teacher neural network identifier circuitry 308, and/or layer organizer circuitry 310. The example data storage 312 of the illustrated example of FIG. 3 can be implemented by any memory, storage device and/or storage disc for storing data such as flash memory, magnetic media, optical media, etc. Furthermore, the data stored in the example data storage 312 can be in any data format such as binary data, comma delimited data, tab delimited data, structured query language (SQL) structures, image data, etc.

FIG. 4 illustrates a block diagram 400 of an example implementation of the knowledge adjustment circuitry 125 of FIG. 1. In FIG. 4, the knowledge adjustment circuitry 125 includes example student knowledge circuitry 404, example teacher knowledge circuitry 406, example source knowledge applier circuitry 408, example alignment circuitry 410, and/or example data storage 412. The student knowledge circuitry 404, the teacher knowledge circuitry 406, the source knowledge applier circuitry 408, the alignment circuitry 410, and/or the data storage 412 are in communication using an example bus 414.

The student knowledge circuitry 404 identifies the student knowledge from the student neural network identifier circuitry 306 and defines the student neural network based on student knowledge, where knowledge Kₛ(X)=p (·|Xₘ, θₛ), such that Xₘ corresponds to source mini-batch input Xₘ. The student knowledge circuitry 404 can be used to determine the logits for the student knowledge model, as shown in connection with FIG. 1, such that a neural network can produce class probabilities by using a softmax output layer that converts a logit computed for each class into a probability by comparing the logit with other logits.

The teacher knowledge circuitry 406 identifies the teacher knowledge from the teacher neural network identifier circuitry 308 and defines the teacher neural network based on teacher knowledge, where knowledge Kₜ(X)=p (·|Xₘ^{aug}, θₜ), such that Xₘ^{aug} corresponds to augmented data input Xₘ^{aug}. The knowledge adjustment circuitry 125 uses the alignment circuitry 410 to align the student knowledge (K_{S}) with the teacher knowledge (K_{T}). In some examples, the teacher knowledge circuitry 406 determines the logits for the teacher knowledge model, as shown in connection with FIG. 1.

The source knowledge applier circuitry 408 identifies the input data connected to the original source data (e.g., source data 104 of FIG. 1). For example, the source knowledge applier circuitry 408 identifies which data input corresponds to data associated with the source knowledge and has not been augmented during the data generation phase of the parallel double-batched self-distillation process. For example, based on the source knowledge applier circuitry 408, the alignment circuitry 410 identifies which batch of data requires further random permutation to allow for knowledge alignment. For example, during training of the neural network, the source knowledge applier circuitry 408 can feed the mini-batch Xₘ derived from the source data into the student neural network (M_{S}) and the transformed mini-batch (e.g., augmented data) Xₘ^{aug} into the teacher neural network (M_{T}).

The alignment circuitry 410 aligns the student knowledge and the teacher knowledge using knowledge augmentation. For example, the logits of student-derived knowledge 126 of FIG. 1 are passed through random permutation to achieve knowledge alignment 128, as previous described in connection with random permutations performed to generated augmented data 106 (e.g., involving the use of source data 104), while logits of teacher-derived knowledge 130 are passed directly to the self-distillation circuitry 135, such that output from the knowledge alignment circuitry 125 is provided to the self-distillation circuitry 135, which represents knowledge distillation (KD). In some examples, the alignment can include random permutation performed as part of the original MixUp data augmentation method used by the data generation circuitry 101.

The data storage 412 can be used to store any information associated with the student knowledge circuitry 404, teacher knowledge circuitry 406, source knowledge applier circuitry 408, and/or alignment circuitry 410. The example data storage 412 of the illustrated example of FIG. 4 can be implemented by any memory, storage device and/or storage disc for storing data such as flash memory, magnetic media, optical media, etc. Furthermore, the data stored in the example data storage 412 can be in any data format such as binary data, comma delimited data, tab delimited data, structured query language (SQL) structures, image data, etc.

FIG. 5 illustrates a block diagram 500 of an example implementation of the self-distillation circuitry 135 of FIG. 1. In FIG. 5, the self-distillation circuitry 135 includes example mutual distillation circuitry 504, example ensemble distillation circuitry 506, example loss identifier circuitry 508, example analyzer circuitry 510, and/or example data storage 512. The mutual distillation circuitry 504, the ensemble distillation circuitry 506, the loss identifier circuitry 508, the analyzer circuitry 510, and/or the data storage 512 are in communication using an example bus 514.

The mutual distillation circuitry 504 operates on the outputs of the knowledge adjustment circuitry 125 to determine loss associated with the teacher knowledge and the student knowledge data inputs. For example, the mutual distillation circuitry 504 identifies loss in accordance with Equations 4 and 5:

$${loss}_{t 2 s} = D ( {K}_{s} \vert \vert {K}_{t}^{a u g} ) \qquad Equation 4$$

$${loss}_{s 2 t} = D ( {K}_{t}^{a u g} \vert \vert {K}_{s} ) \qquad Equation 5$$

For example, the teacher to student knowledge loss (t2s) is defined as the divergence between the student knowledge (Kₛ) and the augmented teacher knowledge (Kₜ^{aug}). Likewise, the student to teacher knowledge loss (s2t) is defined as the divergence between the augmented teacher knowledge (Kₜ^{aug}) and the student knowledge (Kₛ). In some examples, the mutual distillation circuitry 504 uses Kullback-Liebler (KL) divergence to calculate the loss associated with student knowledge and/or teacher knowledge (e.g., to determine how a first probability distribution differs from a second, reference probability distribution). For example, a KL divergence for discrete probability distributions P and Q can be defined as D_{KL}(P∥Q). As shown in Equations 4 and 5, the KL divergence can be based on student knowledge (Kₛ) and the augmented teacher knowledge (Kₜ^{aug}), as shown using D (Kₛ∥Kₜ^{aug}) and D (Kₜ^{aug}∥Kₛ).

The ensemble distillation circuitry 506 performs ensemble distillation to identify loss associated with knowledge distillation from the ensemble branch to the teacher and/or student branch. For example, the ensemble distillation circuitry 506 determines the ensemble knowledge (e.g., K_{ensemble}) in accordance with Equation 6:

$${K}_{e n s e m b l e} = α * {K}_{t}^{a u g} + ( 1 - α ) * {K}_{s} \qquad Equation 6$$

In the example of Equation 6, the ensemble knowledge (e.g., K_{ensemble}) is determined based on student knowledge (Kₛ) and the augmented teacher knowledge (Kₜ^{aug}). In some examples, losses in the self-distillation module are added together to form a total KD loss (e.g., based on alpha (α) hyperparameter values). To identify the total KD loss using the loss identifier circuitry 508, losses associated with the ensemble knowledge are determined using Equations 7 and 8:

$${loss}_{e 2 s} = D ( {K}_{s} \vert \vert {K}_{e n s e m b l e} ) \qquad Equation 7$$

$${loss}_{e 2 t} = D ( {K}_{t} \vert \vert {K}_{e n s e m b l e} ) \qquad Equation 8$$

For example, the ensemble to student knowledge loss (e2s) is defined as the divergence between student knowledge (Kₛ) and the ensemble knowledge (K_{ensemble}). Likewise, the ensemble to teacher knowledge loss (e2t) is defined as the divergence between teacher knowledge (Kₜ) and the ensemble knowledge (K_{ensemble}). In the example of Equation 7, KL divergence is identified using student knowledge (Kₛ) and the ensemble knowledge (K_{ensemble}) to determine a loss on ensemble logits when using student knowledge. In the example of Equation 8, KL divergence is identified using teacher knowledge (Kr) and the ensemble knowledge (K_{ensemble}) to determine a loss on ensemble logits when using teacher knowledge.

The loss identifier circuitry 508 determines the total loss based on losses identified using the mutual distillation circuitry 504 and/or the ensemble distillation circuitry 506. For example, the loss identifier circuitry 508 determines the total loss (e.g., knowledge distillation (KD) loss) in accordance with Equation 9:

$${loss}_{K D} = {loss}_{t 2 s} + {loss}_{s 2 t} + {loss}_{e 2 t} + {loss}_{e 2 s} \qquad Equation 9$$

In the example of Equation 9, the mutual distillation loss (e.g., lossₜ₂ₛ and lossₛ₂ₜ) is added to the ensemble distillation loss (e.g., lossₑ₂ₜ and lossₑ₂ₛ). In some examples, the final loss determined using the loss identifier circuitry 508 also includes loss between logits from the student branch and ground truth data (e.g., identified using cross-entropy), loss from the teacher branch that is defined by augmentation, and/or loss on the ensemble logits which have the same form as loss identified using the teacher branch. As such, the loss identifier circuitry 508 can be used to determine and/or compare model accuracy and identify any changes to make to the parallel double-batched self-distillation algorithm for improve network performance (e.g., using resource-constrained image recognition applications).

The analyzer circuitry 510 can be used to perform assessment of the parallel double-batched self-distillation algorithm using training datasets (e.g., CIFAR-100, ImageNet-2012, etc.) and various networks adapted as backbones (e.g., including deep, dense, and/or wide convolution neural networks such as ResNet-164, DenseNet-40-12, WiderResNet-28-10, etc.). In some examples, image datasets (e.g., CIFAR-100) can include 60,000 32×32 color images in 100 classes with 600 images per class (e.g., 500 training images and 100 testing images per class). For data augmentation, MixUp-based data augmentation can use a fixed alpha value (e.g., α=1), which results in interpolations (e.g., λ) uniformly distributed between zero and one.

The data storage 512 can be used to store any information associated with the mutual distillation circuitry 504, ensemble distillation circuitry 506, loss identifier circuitry 508, and/or analyzer circuitry 510. The example data storage 512 of the illustrated example of FIG. 5 can be implemented by any memory, storage device and/or storage disc for storing data such as flash memory, magnetic media, optical media, etc. Furthermore, the data stored in the example data storage 512 can be in any data format such as binary data, comma delimited data, tab delimited data, structured query language (SQL) structures, image data, etc.

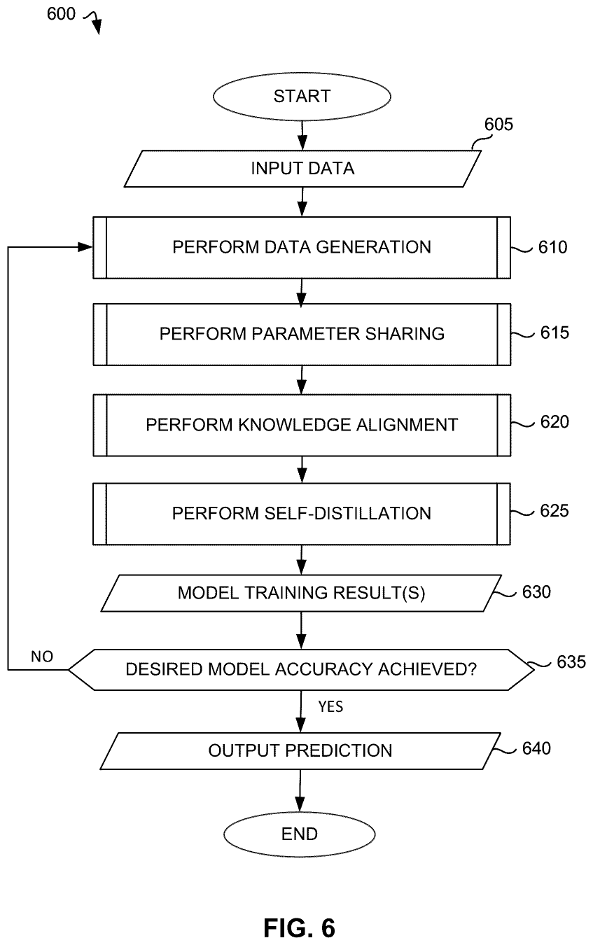

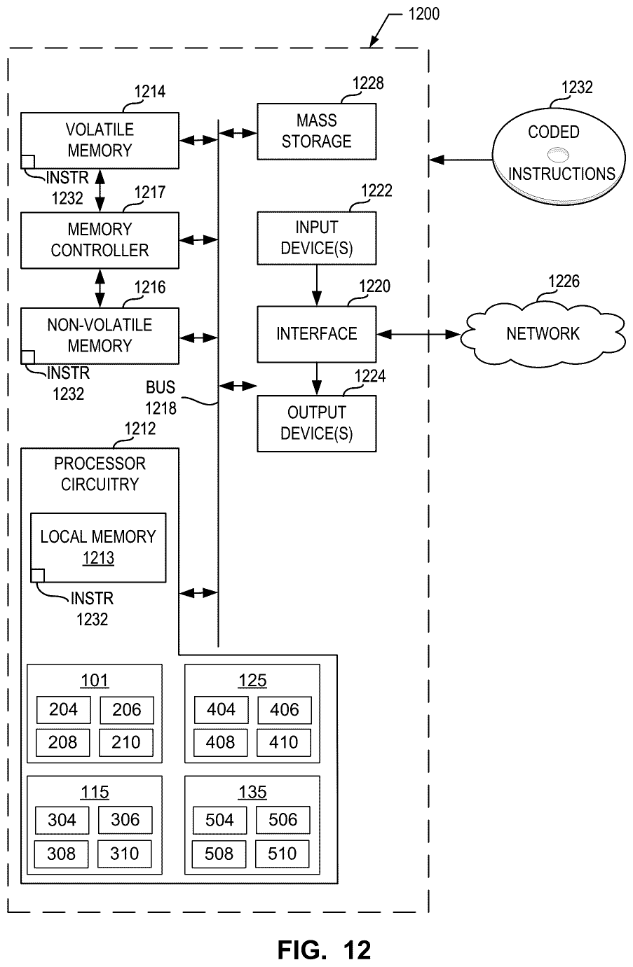

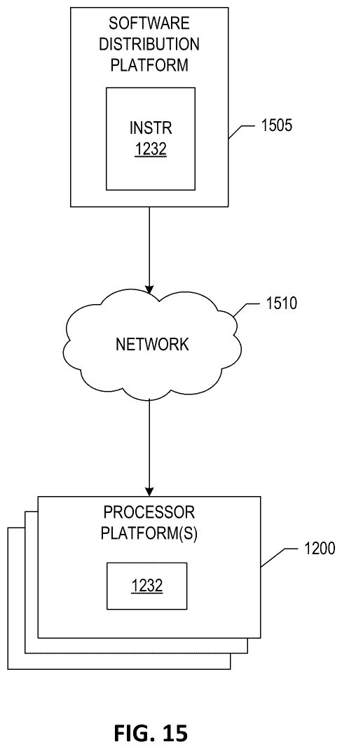

In some examples, the apparatus includes means for means for training model parameters corresponding to at least one of the teacher neural network or the student neural network based on forward propagation or backward propagation. For example, the means for training may be implemented by trainer circuitry 204. In some examples, the trainer circuitry 204 may be implemented by machine executable instructions such as that implemented by at least blocks 605, 610 of FIG. 6 executed by processor circuitry, which may be implemented by the example processor circuitry 1212 of FIG. 12, the example processor circuitry 1500 of FIG. 15, and/or the example Field Programmable Gate Array (FPGA) circuitry 1600 of FIG. 16. In other examples, the patch identification circuitry 204 is implemented by other hardware logic circuitry, hardware implemented state machines, and/or any other combination of hardware, software, and/or firmware. For example, the patch identification circuitry 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the data generation circuitry 101 is illustrated in FIG. 2, one or more of the elements, processes, and/or devices illustrated in FIG. 2 may be combined, divided, re-arranged, omitted, eliminated, and/or implemented in any other way. Further, the example trainer circuitry 204, the example permutation circuitry 206, the example source data output circuitry 208, the example augmented data output circuitry 210, and/or, more generally, the example data generation circuitry 101 of FIG. 2, may be implemented by hardware, software, firmware, and/or any combination of hardware, software, and/or firmware. Thus, for example, any of the trainer circuitry 204, the permutation circuitry 206, the source data output circuitry 208, the augmented data output circuitry 210, and/or, more generally, the data generation circuitry 101 of FIG. 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the trainer circuitry 204, the permutation circuitry 206, the source data output circuitry 208, the augmented data output circuitry 210, and/or, more generally, the data generation circuitry 101 of FIG. 2 is/are hereby expressly defined to include a non-transitory computer readable storage device or storage disk such as a memory, a digital versatile disk (DVD), a compact disk (CD), a Blu-ray disk, etc., including the software and/or firmware. Further still, the example data generation circuitry 101 of FIG. 2 may include one or more elements, processes, and/or devices in addition to, or instead of, those illustrated in FIG. 2, and/or may include more than one of any or all of the illustrated elements, processes and devices.

While an example manner of implementing the parameter share circuitry 115 is illustrated in FIG. 3, one or more of the elements, processes, and/or devices illustrated in FIG. 3 may be combined, divided, re-arranged, omitted, eliminated, and/or implemented in any other way. Further, the example data receiver circuitry 304, the example student neural network identifier circuitry 306, the example teacher neural network identifier circuitry 308, the example layer organizer circuitry 310, and/or, more generally, the example parameter share circuitry 115 of FIG. 3, may be implemented by hardware, software, firmware, and/or any combination of hardware, software, and/or firmware. Thus, for example, any of the data receiver circuitry 304, the student neural network identifier circuitry 306, the teacher neural network identifier circuitry 308, the layer organizer circuitry 310, and/or, more generally, the parameter share circuitry 115 of FIG. 3, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the data receiver circuitry 304, the student neural network identifier circuitry 306, the teacher neural network identifier circuitry 308, the layer organizer circuitry 310, and/or, more generally, the parameter share circuitry 115 of FIG. 3 is/are hereby expressly defined to include a non-transitory computer readable storage device or storage disk such as a memory, a digital versatile disk (DVD), a compact disk (CD), a Blu-ray disk, etc., including the software and/or firmware. Further still, the example parameter share circuitry 115 of FIG. 3 may include one or more elements, processes, and/or devices in addition to, or instead of, those illustrated in FIG. 3, and/or may include more than one of any or all of the illustrated elements, processes and devices.

While an example manner of implementing the knowledge alignment circuitry 125 is illustrated in FIG. 4, one or more of the elements, processes, and/or devices illustrated in FIG. 4 may be combined, divided, re-arranged, omitted, eliminated, and/or implemented in any other way. Further, the example student knowledge circuitry 404, the example teacher knowledge circuitry 406, the example source knowledge applier circuitry 408, the example alignment circuitry 410, and/or, more generally, the example the knowledge alignment circuitry 125 of FIG. 4, may be implemented by hardware, software, firmware, and/or any combination of hardware, software, and/or firmware. Thus, for example, any of the student knowledge circuitry 404, the teacher knowledge circuitry 406, the source knowledge applier circuitry 408, the alignment circuitry 410, and/or, more generally, the knowledge alignment circuitry 125 of FIG. 4, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the student knowledge circuitry 404, the teacher knowledge circuitry 406, the source knowledge applier circuitry 408, the alignment circuitry 410, and/or, more generally, the knowledge alignment circuitry 125 of FIG. 4 is/are hereby expressly defined to include a non-transitory computer readable storage device or storage disk such as a memory, a digital versatile disk (DVD), a compact disk (CD), a Blu-ray disk, etc., including the software and/or firmware. Further still, the knowledge alignment circuitry 125 of FIG. 4 may include one or more elements, processes, and/or devices in addition to, or instead of, those illustrated in FIG. 4, and/or may include more than one of any or all of the illustrated elements, processes and devices.

While an example manner of implementing the self-distillation circuitry 135 is illustrated in FIG. 5, one or more of the elements, processes, and/or devices illustrated in FIG. 5 may be combined, divided, re-arranged, omitted, eliminated, and/or implemented in any other way. Further, the example mutual distillation circuitry 504, the example ensemble distillation circuitry 506, the example loss identifier circuitry 508, the example analyzer circuitry 510, and/or, more generally, the example self-distillation circuitry 135 of FIG. 5, may be implemented by hardware, software, firmware, and/or any combination of hardware, software, and/or firmware. Thus, for example, any of the mutual distillation circuitry 504, the ensemble distillation circuitry 506, the loss identifier circuitry 508, the analyzer circuitry 510, and/or, more generally, the self-distillation circuitry 135 of FIG. 5, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the mutual distillation circuitry 504, the ensemble distillation circuitry 506, the loss identifier circuitry 508, and/or the analyzer circuitry 510 is/are hereby expressly defined to include a non-transitory computer readable storage device or storage disk such as a memory, a digital versatile disk (DVD), a compact disk (CD), a Blu-ray disk, etc., including the software and/or firmware. Further still, the self-distillation circuitry 135 of FIG. 5 may include one or more elements, processes, and/or devices in addition to, or instead of, those illustrated in FIG. 5, and/or may include more than one of any or all of the illustrated elements, processes and devices.

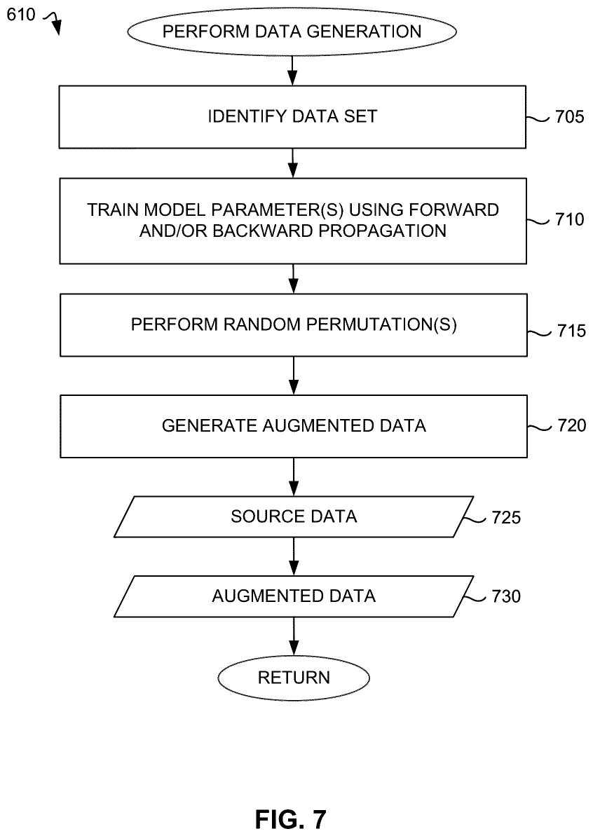

Flowcharts representative of example hardware logic circuitry, machine readable instructions, hardware implemented state machines, and/or any combination thereof for implementing the data generation circuitry 101 of FIG. 2 are shown in FIGS. 6 and/or 7. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 16 and/or 17. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 6, 7, many other methods of implementing the example data generation circuitry 101 of FIG. 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

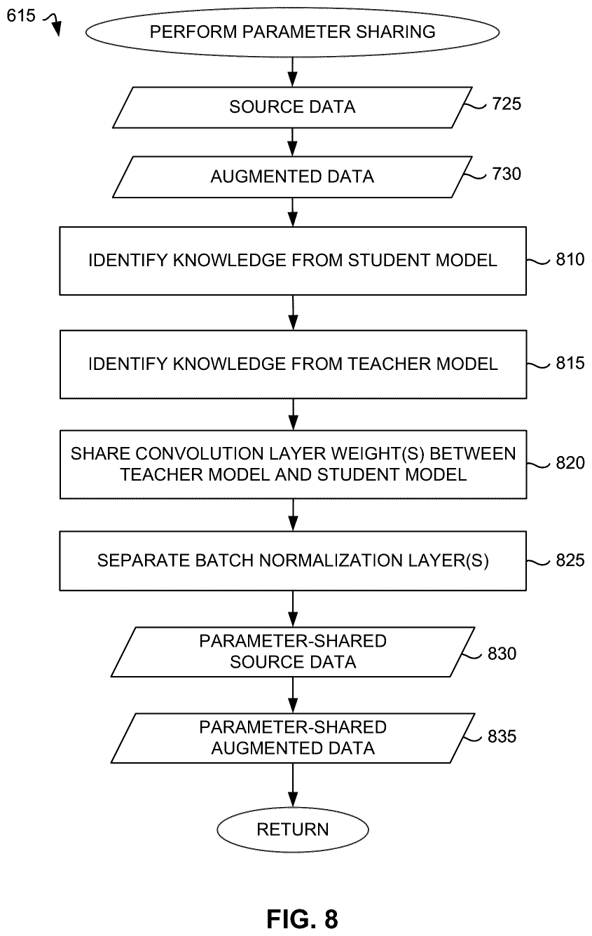

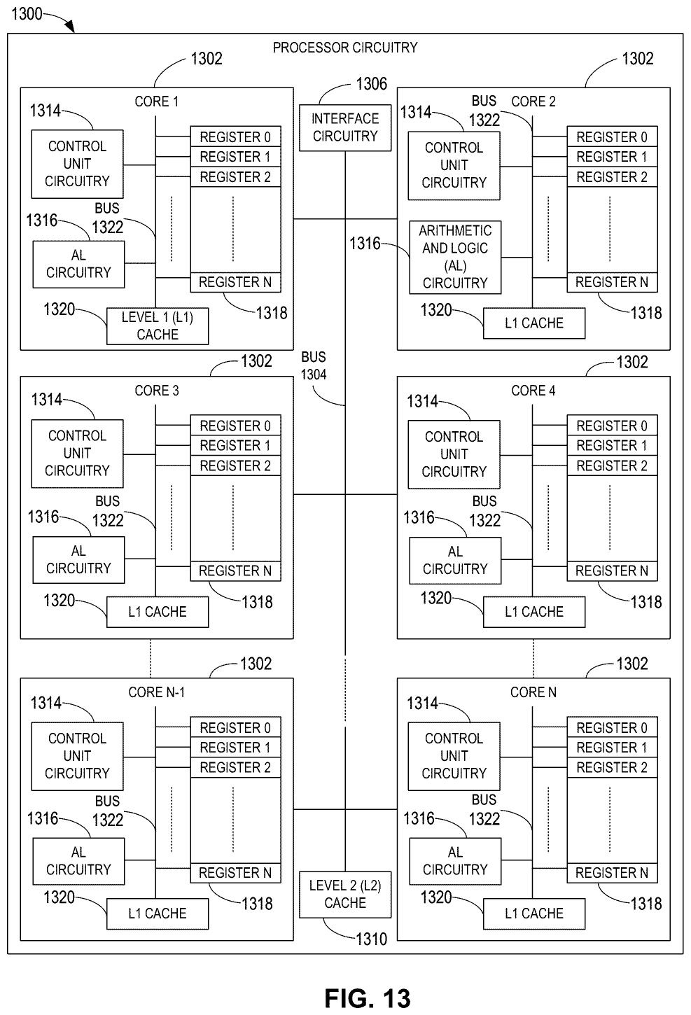

Flowcharts representative of example hardware logic circuitry, machine readable instructions, hardware implemented state machines, and/or any combination thereof for implementing the parameter share circuitry 115 of FIG. 3 are shown in FIGS. 6 and/or 8. The machine readable instructions may be one or more executable programs or portion(s) of an executable program for execution by processor circuitry, such as the processor circuitry 1312 shown in the example processor platform 1300 discussed below in connection with FIG. 13 and/or the example processor circuitry discussed below in connection with FIGS. 16 and/or 17. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 6, 8, many other methods of implementing the parameter share circuitry 115 of FIG. 3 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

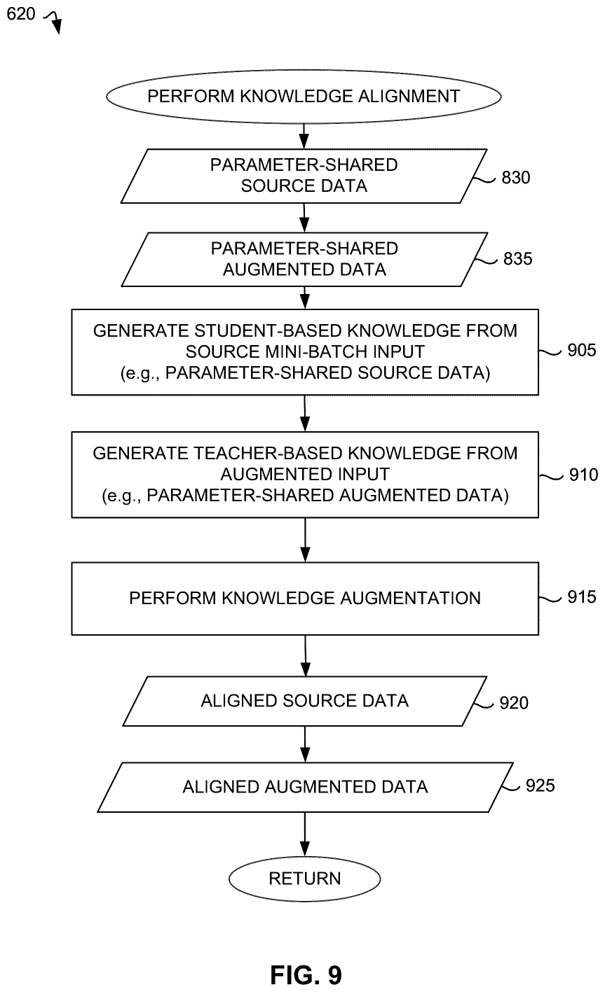

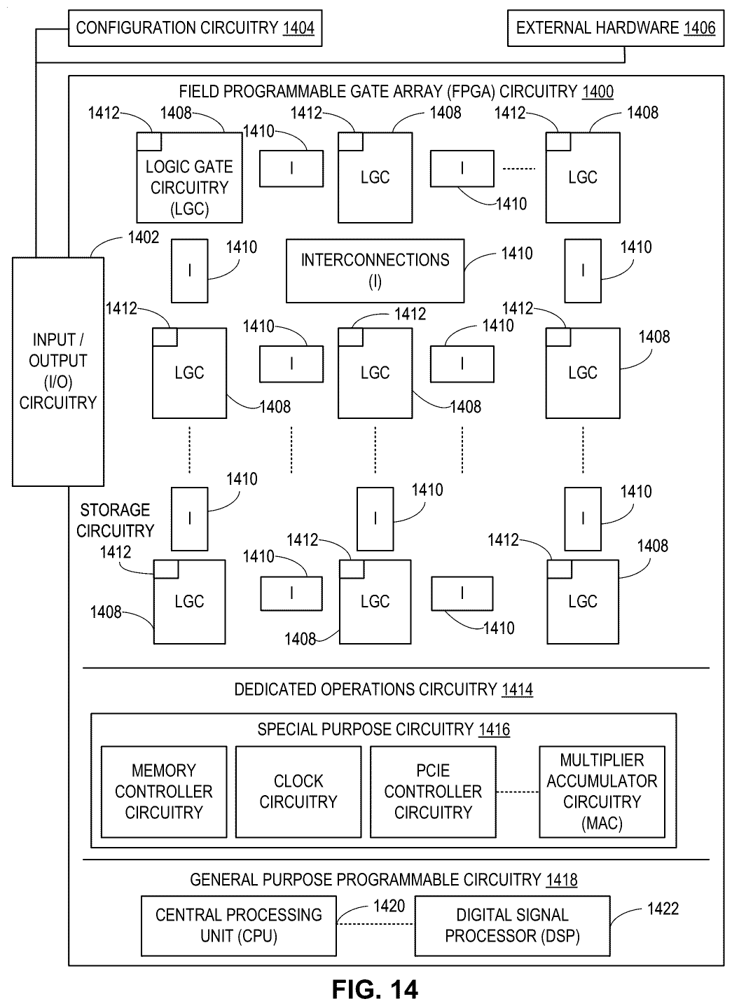

Flowcharts representative of example hardware logic circuitry, machine readable instructions, hardware implemented state machines, and/or any combination thereof for implementing the knowledge alignment circuitry 125 of FIG. 4 are shown in FIGS. 6 and/or 9. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 16 and/or 17. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 6, 9, many other methods of implementing the knowledge adjustment circuitry 125 of FIG. 4 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

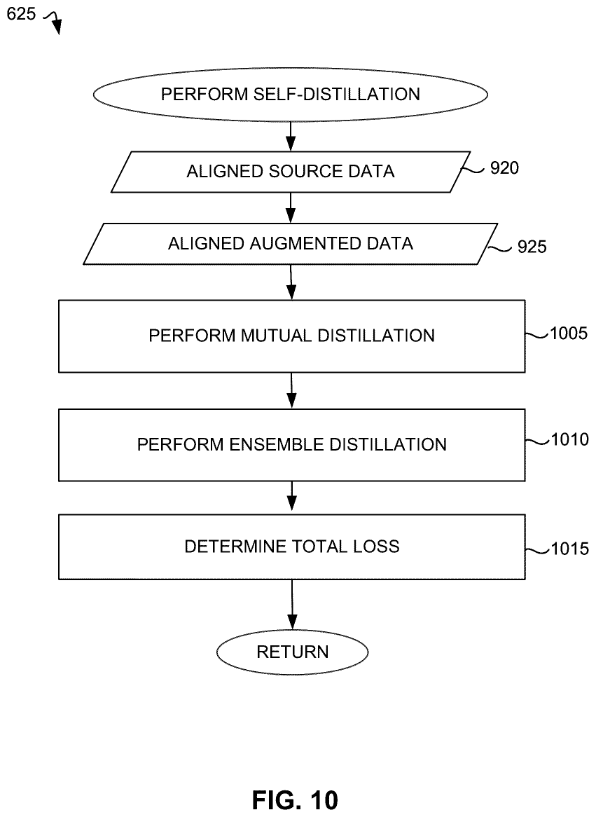

Flowcharts representative of example hardware logic circuitry, machine readable instructions, hardware implemented state machines, and/or any combination thereof for implementing the self-distillation circuitry 135 of FIG. 5 are shown in FIGS. 6 and/or 10. The machine readable instructions may be one or more executable programs or portion(s) of an executable program for execution by processor circuitry, such as the processor circuitry 1512 shown in the example processor platform 1500 discussed below in connection with FIG. 15 and/or the example processor circuitry discussed below in connection with FIGS. 16 and/or 17. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 6, 10, many other methods of implementing the self-distillation circuitry 135 of FIG. 5 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 6-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions 600 that may be executed by example processor circuitry to implement the data generation circuitry 101 of FIG. 2, the parameter share circuitry 115 of FIG. 3, the knowledge alignment circuitry 125 of FIG. 4, and/or the self-distillation circuitry 135 of FIG. 5. In the example of FIG. 6, the data generation circuitry 101 receives input data consists of a dataset of training images (block 605). Once the images are received, the data generation circuitry 101 performs data generation to produce a source dataset (e.g., source data 104 of FIG. 1) and/or an augmentation dataset (e.g., augmented data 106) (block 610), as described above and in connection with FIG. 7. Once the datasets have been generated, the parameter share circuitry 115 performs parameter sharing to allow the convolutional (CONV) layers of the network to be shared while the batch normalization layers are separated (block 615), as described above and in connection with FIG. 8. The output from the parameter share circuitry 115 is used by the knowledge alignment circuitry 125 to perform knowledge alignment, such that the student knowledge (e.g., associated with the source data) and the teacher knowledge (e.g., associated with the augmented data) are aligned (block 620), as described above and in connection with FIG. 9. The output from the knowledge alignment circuitry 125 is then received by the self-distillation circuitry 135 to perform knowledge distillation and identify the total loss function associated with mutual distillation and/or ensemble distillation of the input student knowledge and/or teacher knowledge (block 625), as described above and in connection with FIG. 10. Results of the model can be assessed using the analyzer circuitry 510 of the self-distillation circuitry 135 based on the performance of the parallel double-batched self-distillation algorithm on a training dataset (e.g., CIFAR, etc.) using a neural network as a backbone (e.g., ResNet, DenseNet, etc.) (block 630). If target model accuracy is achieved (e.g., based on the selection of a particular data augmentation methodology, etc.), the parallel double-batched self-distillation algorithm can be deployed in resource-constrained environments (block 635). If additional improvements in accuracy are required to meet the target, which may be based on user input, a configuration parameter, a compiler setting, etc., control returns to the data generation circuitry 101 of FIG. 1 to proceed with data generation once the desired changes to the algorithm have been implemented (block 610). Once the training is complete, the self-distillation circuitry 135 can output a prediction associated with a given input dataset (block 635). For example, the output can be used to predict the classification of a certain image based on the training performed in connection with the parallel double-batched self-distillation algorithm.

FIG. 7 is a flowchart representative of example machine readable instructions 610 that may be executed by example processor circuitry to implement the data generation circuitry 101 of FIG. 2. In the example of FIG. 7, the data generation circuitry 101 identifies the input dataset (e.g., image dataset) (block 705). Once the dataset is received, the trainer circuitry 204 trains model parameter(s) using forward and/or backward propagation (block 710). In some examples, the trainer circuitry 204 calculates a loss function and uses backpropagation to adjust neural network-associated weights to make the output more accurate, given that during forward propagation weights are initialized randomly. The permutation circuitry 206 performs random permutation(s) on the obtained dataset of images as part of generating augmented data (block 715). For example, the permutation circuitry 206 performs random permutation of a sequence of samples. The augmented data output circuitry 210 generates augmented data based on a data augmentation method (e.g., MixUp, etc.) that uses random permutation(s) to obtain augmented image data (e.g., by mixing randomly cropped images and/or concatenating the cropped images together to form new images, etc.) (block 720). The source data output circuitry 208 can be used to identify and/or output the source data (e.g., data that is not augmented) for further processing using the parameter share circuitry 115 of FIG. 3 (block 725). In some examples, the augmented data output circuitry 210 can be used to output augmented data for further processing using the parameter share circuitry 115 once the data augmentation is complete (block 730).

FIG. 8 is a flowchart representative of example machine readable instructions 615 that may be executed by example processor circuitry to implement the parameter share circuitry 115 of FIG. 3. In the example of FIG. 8, the data receiver circuitry 304 receives the source data (block 725) and/or the augmented data (block 730) from the data generation circuitry 101 of FIG. 2. The student neural network identifier circuitry 306 identifies knowledge associated with the student neural network based on the data input (block 810). The teacher neural network identifier circuitry 308 identifies knowledge associated with the teacher neural network based on the data input (block 815). For example, the student neural network identifier circuitry 306 and the teacher neural network identifier circuitry 308 allow for weight sharing between convolution (CONV) layers as shown in the example of FIG. 1 to allow the network to obtain more knowledge in common between the teacher neural network and/or the student neural network, forming different distributions through the batch normalization layers to improve network accuracy (block 820). For example, the layer organizer circuitry 310 can separate batch normalization layer(s) of the student neural network (e.g., student knowledge) and/or the teacher neural network (e.g., teacher knowledge) to permit learning more data distribution in the two branches of data (e.g., student and/or teacher data branches) to increase network performance and final output and/or classification accuracy. The layer organizer circuitry 310 outputs the parameter-shared source data (block 830) obtained using the student neural network identifier circuitry 306 and/or the parameter-shared augmented data (block 835) obtained using the teacher neural network identifier circuitry 308.

FIG. 9 is a flowchart representative of example machine readable instructions 620 that may be executed by example processor circuitry to implement the knowledge alignment circuitry 125 of FIG. 4. In the example of FIG. 9, the parameter-shared source data (block 830) and/or the parameter-shared augmented data (block 835) is input into the knowledge alignment circuitry 125. The student knowledge circuitry 404 generates student-based knowledge from source mini-batch input as part of initiating alignment of the knowledge prior to performing knowledge distillation (block 905). Likewise, the teacher knowledge circuitry 406 generates teacher-based knowledge from augmented input (block 910). For example, the alignment circuitry 410 aligns the student-based knowledge with the teacher-based knowledge by performing data augmentation using random permutation (e.g., MixUp data augmentation, etc.) (block 915). For example, the teacher-based knowledge has a previous data augmentation performed in the data generation stage (e.g., using data generation circuitry 101 of FIG. 1), while the student-based knowledge requires augmentation to make the two models aligned, as shown in the example of FIG. 1. The alignment circuitry 410 outputs the aligned source data (block 920) corresponding to the augmented student-based knowledge model and/or the aligned augmented data corresponding to the teacher-based knowledge model (block 925).

FIG. 10 is a flowchart representative of example machine readable instructions 625 that may be executed by example processor circuitry to implement the self-distillation circuitry 135 of FIG. 5. In the example of FIG. 10, the mutual distillation circuitry 504 receives the aligned source data (block 920) and/or the aligned augmented data (block 925) of FIG. 9. The mutual distillation circuitry 504 performs mutual distillation by operating on the two input branches of data to identify losses associated with the mutual distillation model (e.g., using KL divergence) based on the student knowledge and/or the augmented teacher knowledge identified using the knowledge alignment circuitry 125 of FIG. 4 (block 1005). Likewise, the ensemble distillation circuitry 506 performs ensemble distillation by operating on the two input branches of data to identify losses associated with the ensemble distillation model (e.g., using ensemble knowledge determined based on the student knowledge and the augmented teacher knowledge and compared to the student-derived or teacher-derived knowledge using KL divergence) (block 1010). The loss identifier circuitry 508 identifies the total losses in the self-distillation module by adding the losses identified using the mutual distillation circuitry 504 to the losses identified using the ensemble distillation circuitry 506 (block 1015), allowing overall model accuracy to be evaluated using the analyzer circuitry 510, as described in connection with FIG. 6.

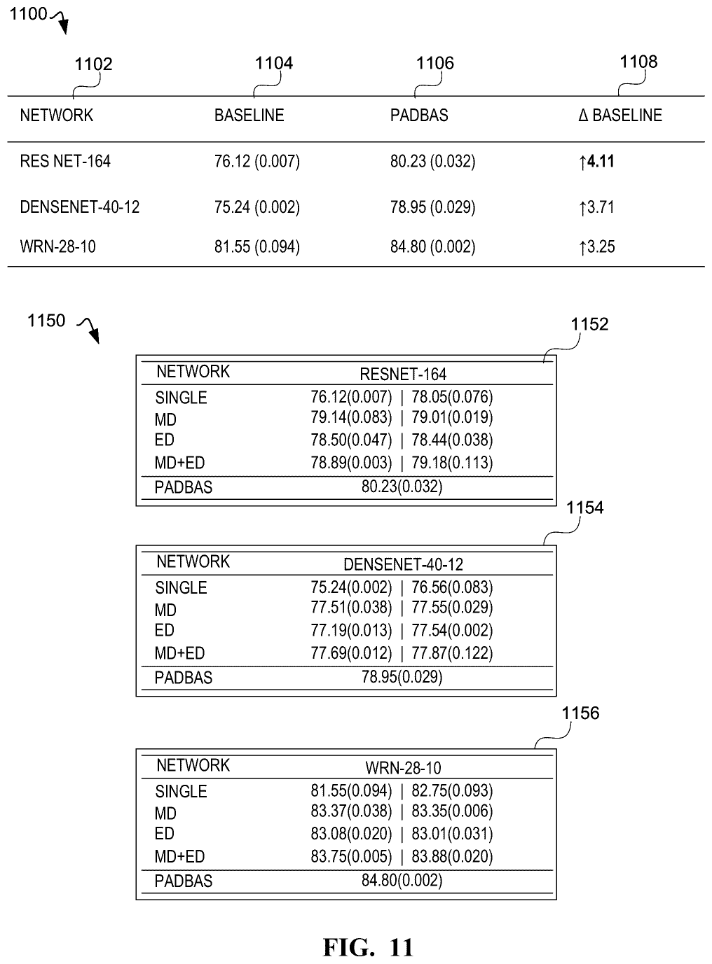

FIG. 11 illustrates example accuracy results 1100, 1150 obtained when training machine learning and/or computer vision algorithms on a given network, including with the use of the parallel double-batched self-distillation process disclosed herein. As described in connection with FIGS. 6-10, parallel double-batched self-distillation (PadBas) can be used to implement high-performance model training not limited to the training of compact and/or accurate models. In the example of FIG. 11, PadBas is tested using a CIFAR-100 dataset, which is widely used for classification tasks associated with neural network model training. For comparison, deeper, denser, and/or wider example network(s) 1102 are used (e.g., ResNet-164, DenseNet-40-12, and WRN-28-10). As described in connection with FIG. 1, the data generation circuitry 101 uses MixUp data augmentation as the data transformation method, with the network(s) 1102 sharing convolution parameter(s) and with the batch normalization layer(s) separated (e.g., as shown in connection with the parameter share circuitry 115 of FIG. 1). In the example of FIG. 11, results are shown for an example baseline 1104, an example PadBas method implementation 1106 in accordance with teachings of this disclosure, and an example change in the baseline 1108. In the example of FIG. 11, the PadBas method implementation 1106 improves the single model of ResNet-164 from a baseline of 76.12% to 80.23%, which represents a 4.11% higher accuracy than the baseline. With a denser network such as DenseNet-40-12, use of the PadBas method implementation 1106 results in a 3.71% improvement over the baseline 1104. Likewise, when a wider network (e.g., WRN-28-10) is used as the backbone, PadBas method implementation 1106 results in 83.80% accuracy, which is 3.25% higher than the baseline 1104. Therefore, the PadBas method implementation 1106 can effectively boost model performance with the use of a compact structure.

In some examples, various knowledge distillation (KD) configurations can be tested, as shown in the example results 1150 of FIG. 11. For example, in FIG. 1, the data generation includes output source data 104 and augmented data 106. However, it is possible to test whether two outputs that are both augmented data (e.g., augmented data 106) improve model efficiency. In the example of FIG. 11, two MixUp data augmentation inputs, including a first branch and a second branch of a convolutional neural network, are shown for various models 1151 (e.g., single, mutual distillation (MD), ensemble distillation (ED), and a combination of MD and ED, etc.), including the PadBas methodology disclosed herein. The example network(s) tested include an example ResNet-164 network 1152, an example DenseNet-40-12 network 1154, and/or an example WRN-28-10 network 1156. Based on the results shown in FIG. 1, ResNet-164 result with the highest accuracy (79.18%) shows a 1.05% lower accuracy when compared to the PadBas methodology. Likewise, the PadBas methodology shows a 1.08% improved accuracy compared to the highest accuracy observed using the DenseNet-40-12 network (77.87%), and a 0.92% improved accuracy when compared to the highest accuracy observed using the WRN-28-10 network (83.88%). Overall, knowledge assimilation shows increased performance on different input data since there is more difference between source data and augmented data as compared to when the two inputs both correspond to augmented data, although model strength increases when training is performed using augmented data as compared to source data.

FIG. 12 is a block diagram of an example processing platform 1200 including processor circuitry structured to execute the example machine readable instructions of FIGS. 6 and/or 7 to implement the data generation circuitry 101 of FIG. 2. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device. The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the trainer circuitry 204, the permutation circuitry 206, the source data output circuitry 208, and/or the augmented data output circuitry 210, as part of the data generation circuitry 101. Furthermore, the processor circuitry 1212 implements the data receiver circuitry 304, the student neural network identifier circuitry 306, the teacher neural network identifier circuitry 308, and/or the layer organizer circuitry 310, as part of the parameter share circuitry 115. In some examples, the processor circuitry 1212 also implements the student knowledge circuitry 404, the teacher knowledge circuitry 406, the source knowledge applier circuitry 408, and/or the alignment circuitry 410, in connection with the knowledge alignment circuitry 125. Likewise, the processor circuitry 1212 implements the mutual distillation circuitry 504, the ensemble distillation circuitry 506, the loss identifier circuitry 508, and/or the analyzer circuitry 510 associated with the self-distillation circuitry 135.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1222 are connected to the interface circuitry 1220. The input device(s) 1222 permit(s) a user to enter data and/or commands into the processor circuitry 1212. The input device(s) 1202 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output devices 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1232, which may be implemented by the machine readable instructions of FIGS. 6-7, may be stored in the mass storage device 1228, in the volatile memory 1214, in the non-volatile memory 1216, and/or on a removable non-transitory computer readable storage medium such as a CD or DVD.

FIG. 13 is a block diagram 1300 of an example implementation of the processor circuitry of FIG. 12. In this example, the processor circuitry 1212 of FIG. 12 is implemented by a microprocessor 1300. For example, the microprocessor 1300 may implement multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 6-10.

The cores 1302 may communicate by an example bus 1304. In some examples, the bus 1304 may implement a communication bus to effectuate communication associated with one(s) of the cores 1302. For example, the bus 1304 may implement at least one of an Inter-Integrated Circuit (I2C) bus, a Serial Peripheral Interface (SPI) bus, a PCI bus, or a PCIe bus. Additionally or alternatively, the bus 1304 may implement any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the L1 cache 1320, and an example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The bus 1322 may implement at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram 1400 of another example implementation of the processor circuitry of FIG. 12. In this example, the processor circuitry 1212 is implemented by FPGA circuitry 1400. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 6-10 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIGS. 6-10. In particular, the FPGA 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIGS. 6-10. As such, the FPGA circuitry 1400 may be structured to effectively instantiate some or all of the machine readable instructions of the flowcharts of FIGS. 6-10 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 6-10 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware (e.g., external hardware circuitry) 1406. For example, the configuration circuitry 1404 may implement interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may implement the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and interconnections 1410 are configurable to instantiate one or more operations that may correspond to at least some of the machine readable instructions of FIGS. 6-10 and/or other desired operations. The logic gate circuitry 1408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12 many other approaches are contemplated. For example, as mentioned above, modern FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by the flowcharts of FIGS. 6-10 may be executed by one or more of the cores 1402 of FIG. 14 and a second portion of the machine readable instructions represented by the flowchart of FIGS. 6-10 may be executed by the FPGA circuitry 1400 of FIG. 14.

In some examples, the processor circuitry 1212 of FIG. 12 may be in one or more packages. For example, the processor circuitry 1300 of FIG. 13 and/or the FPGA circuitry 1400 of FIG. 14 may be in one or more packages. In some examples, an XPU may be implemented by the processor circuitry 1212 of FIG. 12 which may be in one or more packages. For example, the XPU may include a CPU in one package, a DSP in another package, a GPU in yet another package, and an FPGA in still yet another package.

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232 which may correspond to the example machine readable instructions of FIGS. 6-10, as described above. The one or more servers of the example software distribution platform 1505 are in communication with a network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions of FIGS. 6-10, may be downloaded to the example processor platform 1200 which is to execute the machine readable instructions 1232 to implement the data generation circuitry 101, the parameter share circuitry 115, the knowledge alignment circuitry 125, and/or the self-distillation circuitry 135. In some example, one or more servers of the software distribution platform 1805 periodically offer, transmit, and/or force updates to the software (e.g., the example machine readable instructions 1232 of FIG. 12) to ensure improvements, patches, updates, etc., are distributed and applied to the software at the end user devices.

From the foregoing, it will be appreciated that methods and apparatus disclosed herein permit the training of diverse types of deep neural networks (DNNs) with knowledge distillation to achieve a competitive accuracy when compared to the use of a teacher-based network on a single model. For example, parallel double-batched self-distillation (PadBas) as disclosed herein significantly improves accuracy on a single network, even when the network becomes deeper, denser, and/or wider, allowing the final model to be used in diverse artificial intelligence (AI)-based applications. As such, example methods and apparatus disclosed herein allow for ease of operation associated with obtaining double-batched data and create a compact network structure with a parameter sharing scheme that can be applied to any kind of DNN with knowledge distillation, making parallel double-batched self-distillation applicable for use in diverse artificial intelligence (AI)-based tasks.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

Example methods, apparatus, systems, and articles of manufacture to perform parallel double-batched self-distillation in resource-constrained image recognition applications are disclosed herein. Further examples and combinations thereof include the following:

Example 1 includes an apparatus for knowledge distillation in a neural network, the apparatus comprising at least one memory, instructions in the apparatus, and processor circuitry to execute the instructions to identify a source data batch and an augmented data batch, the augmented data generated based on at least one data augmentation technique, share one or more parameters between a student neural network corresponding to the source data batch and a teacher neural network corresponding to the augmented data batch, the one or more parameters including one or more convolution layers to be shared between the teacher neural network and the student neural network, align knowledge corresponding to the teacher neural network and the student neural network, the knowledge corresponding to the one or more parameters shared between the student neural network and the teacher neural network, the knowledge aligned based on application of the at least one data augmentation technique on student knowledge of the student neural network, and identify a loss associated with at least one of mutual distillation or ensemble distillation, the loss to characterize image recognition accuracy of the neural network.

Example 2 includes the apparatus of example 1, wherein batch normalization layers of the teacher neural network and the student neural network are to remain separate when the one or more parameters are shared between the student neural network and the teacher neural network.

Example 3 includes the apparatus of example 1, wherein the at least one data augmentation technique includes at least one of a MixUp data augmentation technique, a CutMix data augmentation technique, or an AutoAug data augmentation technique.

Example 4 includes the apparatus of example 1, wherein the processor circuitry is to identify loss associated with the at least one of the mutual distillation or the ensemble distillation based on Kullback-Leibler divergence.

Example 5 includes the apparatus of example 1, wherein the processor circuitry is to train model parameters corresponding to at least one of the teacher neural network or the student neural network based on forward propagation or backward propagation.

Example 6 includes the apparatus of example 1, wherein the at least one data augmentation technique includes a random permutation function, the random permutation function to adjust an image based on a beta distribution.

Example 7 includes the apparatus of example 1, wherein the loss is a first loss, and the processor circuitry is to determine the first loss based on a combination of a second loss associated with the mutual distillation and a third loss associated with the ensemble distillation.

Example 8 includes a method for knowledge distillation in a neural network, comprising identifying a source data batch and an augmented data batch, the augmented data generated based on at least one data augmentation technique, sharing one or more parameters between a student neural network corresponding to the source data batch and a teacher neural network corresponding to the augmented data batch, the one or more parameters including one or more convolution layers to be shared between the teacher neural network and the student neural network, aligning knowledge corresponding to the teacher neural network and the student neural network, the knowledge corresponding to the one or more parameters shared between the student neural network and the teacher neural network, the knowledge aligned based on application of the at least one data augmentation technique on student knowledge of the student neural network, and identifying a loss associated with at least one of mutual distillation or ensemble distillation, the loss to characterize image recognition accuracy of the neural network.

Example 9 includes the method of example 8, wherein batch normalization layers of the teacher neural network and the student neural network are to remain separate when the one or more parameters are shared between the student neural network and the teacher neural network.

Example 10 includes the method of example 8, wherein the at least one data augmentation technique includes at least one of a MixUp data augmentation technique, a CutMix data augmentation technique, or an AutoAug data augmentation technique.

Example 11 includes the method of example 8, further including identifying loss associated with the at least one of the mutual distillation or the ensemble distillation based on Kullback-Leibler divergence.

Example 12 includes the method of example 8, further including training model parameters corresponding to at least one of the teacher neural network or the student neural network based on forward propagation or backward propagation.

Example 13 includes the method of example 8, wherein the at least one data augmentation technique includes a random permutation function, the random permutation function to adjust an image based on a beta distribution.

Example 14 includes the method of example 8, wherein the loss is a first loss, further including determining the first loss based on a combination of a second loss associated with the mutual distillation and a third loss associated with the ensemble distillation.

Example 15 includes at least one non-transitory computer readable storage medium comprising computer readable instructions which, when executed, cause one or more processors to at least identify a source data batch and an augmented data batch, the augmented data generated based on at least one data augmentation technique, share one or more parameters between a student neural network corresponding to the source data batch and a teacher neural network corresponding to the augmented data batch, the one or more parameters including one or more convolution layers to be shared between the teacher neural network and the student neural network, align knowledge corresponding to the teacher neural network and the student neural network, the knowledge corresponding to the one or more parameters shared between the student neural network and the teacher neural network, the knowledge aligned based on application of the at least one data augmentation technique on student knowledge of the student neural network, and identify a loss associated with at least one of mutual distillation or ensemble distillation, the loss to characterize image recognition accuracy of the neural network.

Example 16 includes the at least one non-transitory computer readable storage medium as defined in example 15, wherein the computer readable instructions cause the one or more processors to identify loss associated with the at least one of the mutual distillation or the ensemble distillation based on Kullback-Leibler divergence.

Example 17 includes the at least one non-transitory computer readable storage medium as defined in example 15, wherein the computer readable instructions cause the one or more processors to train model parameters corresponding to at least one of the teacher neural network or the student neural network based on forward propagation or backward propagation

Example 18 includes the at least one non-transitory computer readable storage medium as defined in example 15, wherein the computer readable instructions cause the one or more processors to adjust an image based on a beta distribution using the at least one data augmentation technique.

Example 19 includes the at least one non-transitory computer readable storage medium as defined in example 15, wherein the computer readable instructions cause the one or more processors to determine the first loss based on a combination of a second loss associated with the mutual distillation and a third loss associated with the ensemble distillation.

Example 20 includes the at least one non-transitory computer readable storage medium as defined in example 15, wherein the computer readable instructions cause the one or more processors to retain separate batch normalization layers of the teacher neural network and the student neural network when the one or more parameters are shared between the student neural network and the teacher neural network.

Example 21 includes an apparatus for knowledge distillation in a neural network, the apparatus comprising means for identifying a source data batch and an augmented data batch, the augmented data generated based on at least one data augmentation technique, means for sharing one or more parameters between a student neural network corresponding to the source data batch and a teacher neural network corresponding to the augmented data batch, the one or more parameters including one or more convolution layers to be shared between the teacher neural network and the student neural network, means for aligning knowledge corresponding to the teacher neural network and the student neural network, the knowledge corresponding to the one or more parameters shared between the student neural network and the teacher neural network, the knowledge aligned based on application of the at least one data augmentation technique on student knowledge of the student neural network, and means for identifying a loss associated with at least one of mutual distillation or ensemble distillation, the loss to characterize image recognition accuracy of the neural network.

Example 22 includes the apparatus of example 21, wherein batch normalization layers of the teacher neural network and the student neural network are to remain separate when the one or more parameters are shared between the student neural network and the teacher neural network.

Example 23 includes the apparatus of example 21, wherein the at least one data augmentation technique includes at least one of a MixUp data augmentation technique, a CutMix data augmentation technique, or an AutoAug data augmentation technique.

Example 24 includes the apparatus of example 21, wherein the means for identifying a loss associated with the at least one of the mutual distillation or the ensemble distillation includes identifying a loss based on Kullback-Leibler divergence.

Example 25 includes the apparatus of example 21, further including means for training model parameters corresponding to at least one of the teacher neural network or the student neural network based on forward propagation or backward propagation.

Example 26 includes the apparatus of example 21, wherein the at least one data augmentation technique includes a random permutation function, the random permutation function to adjust an image based on a beta distribution.

Example 27 includes the apparatus of example 21, wherein the loss is a first loss, and the means for identifying a loss includes determining the first loss based on a combination of a second loss associated with the mutual distillation and a third loss associated with the ensemble distillation.

The following claims are hereby incorporated into this Detailed Description by this reference, with each claim standing on its own as a separate embodiment of the present disclosure.

What is claimed is:

1. An apparatus for knowledge distillation in a neural network, the apparatus comprising:
at least one memory;
instructions in the apparatus; and
processor circuitry to execute the instructions to:
identify a source data batch and an augmented data batch, the augmented data generated based on at least one data augmentation technique;
share one or more parameters between a student neural network corresponding to the source data batch and a teacher neural network corresponding to the augmented data batch, the one or more parameters including one or more convolution layers to be shared between the teacher neural network and the student neural network;
align knowledge corresponding to the teacher neural network and the student neural network, the knowledge corresponding to the one or more parameters shared between the student neural network and the teacher neural network, the knowledge aligned based on application of the at least one data augmentation technique on student knowledge of the student neural network; and
identify a loss associated with at least one of mutual distillation or ensemble distillation, the loss to characterize image recognition accuracy of the neural network.

2. The apparatus of claim 1, wherein batch normalization layers of the teacher neural network and the student neural network are to remain separate when the one or more parameters are shared between the student neural network and the teacher neural network.

3. The apparatus of claim 1, wherein the at least one data augmentation technique includes at least one of a MixUp data augmentation technique, a CutMix data augmentation technique, or an AutoAug data augmentation technique.

4. The apparatus of claim 1, wherein the processor circuitry is to identify loss associated with the at least one of the mutual distillation or the ensemble distillation based on Kullback-Leibler divergence.

5. The apparatus of claim 1, wherein the processor circuitry is to train model parameters corresponding to at least one of the teacher neural network or the student neural network based on forward propagation or backward propagation.

6. The apparatus of claim 1, wherein the at least one data augmentation technique includes a random permutation function, the random permutation function to adjust an image based on a beta distribution.

7. The apparatus of claim 1, wherein the loss is a first loss, and the processor circuitry is to determine the first loss based on a combination of a second loss associated with the mutual distillation and a third loss associated with the ensemble distillation.

8. A method for knowledge distillation in a neural network, comprising:
identifying a source data batch and an augmented data batch, the augmented data generated based on at least one data augmentation technique;
sharing one or more parameters between a student neural network corresponding to the source data batch and a teacher neural network corresponding to the augmented data batch, the one or more parameters including one or more convolution layers to be shared between the teacher neural network and the student neural network;
aligning knowledge corresponding to the teacher neural network and the student neural network, the knowledge corresponding to the one or more parameters shared between the student neural network and the teacher neural network, the knowledge aligned based on application of the at least one data augmentation technique on student knowledge of the student neural network; and
identifying a loss associated with at least one of mutual distillation or ensemble distillation, the loss to characterize image recognition accuracy of the neural network.

9. The method of claim 8, wherein batch normalization layers of the teacher neural network and the student neural network are to remain separate when the one or more parameters are shared between the student neural network and the teacher neural network.

10. The method of claim 8, wherein the at least one data augmentation technique includes at least one of a MixUp data augmentation technique, a CutMix data augmentation technique, or an AutoAug data augmentation technique.

11. The method of claim 8, further including identifying loss associated with the at least one of the mutual distillation or the ensemble distillation based on Kullback-Leibler divergence.

12. The method of claim 8, further including training model parameters corresponding to at least one of the teacher neural network or the student neural network based on forward propagation or backward propagation.

13. The method of claim 8, wherein the at least one data augmentation technique includes a random permutation function, the random permutation function to adjust an image based on a beta distribution.

14. The method of claim 8, wherein the loss is a first loss, further including determining the first loss based on a combination of a second loss associated with the mutual distillation and a third loss associated with the ensemble distillation.

15. At least one non-transitory computer readable storage medium comprising computer readable instructions which, when executed, cause one or more processors to at least:
identify a source data batch and an augmented data batch, the augmented data generated based on at least one data augmentation technique;
share one or more parameters between a student neural network corresponding to the source data batch and a teacher neural network corresponding to the augmented data batch, the one or more parameters including one or more convolution layers to be shared between the teacher neural network and the student neural network;
align knowledge corresponding to the teacher neural network and the student neural network, the knowledge corresponding to the one or more parameters shared between the student neural network and the teacher neural network, the knowledge aligned based on application of the at least one data augmentation technique on student knowledge of the student neural network; and
identify a loss associated with at least one of mutual distillation or ensemble distillation, the loss to characterize image recognition accuracy of the neural network.

16. The at least one non-transitory computer readable storage medium as defined in claim 15, wherein the computer readable instructions cause the one or more processors to identify loss associated with the at least one of the mutual distillation or the ensemble distillation based on Kullback-Leibler divergence.

17. The at least one non-transitory computer readable storage medium as defined in claim 15, wherein the computer readable instructions cause the one or more processors to train model parameters corresponding to at least one of the teacher neural network or the student neural network based on forward propagation or backward propagation.

18. The at least one non-transitory computer readable storage medium as defined in claim 15, wherein the computer readable instructions cause the one or more processors to adjust an image based on a beta distribution using the at least one data augmentation technique.

19. The at least one non-transitory computer readable storage medium as defined in claim 15, wherein the computer readable instructions cause the one or more processors to determine the first loss based on a combination of a second loss associated with the mutual distillation and a third loss associated with the ensemble distillation.

20. The at least one non-transitory computer readable storage medium as defined in claim 15, wherein the computer readable instructions cause the one or more processors to retain separate batch normalization layers of the teacher neural network and the student neural network when the one or more parameters are shared between the student neural network and the teacher neural network.
